(19) United States
(12) Patent Application Publication
(10) Pub. No.: US 2018/0245623 A1
(43) Pub. Date: Aug. 30, 2018

(54) PROTECTIVE CAP, BALL JOINT COMPRISING A PROTECTIVE CAP OF THIS TYPE AND TWO-POINT LINKAGE COMPRISING A BALL JOINT OF THIS TYPE

(71) Applicant: ZF Friedrichshafen AG, Friedrichshafen (DE)

(72) Inventors: Günter REDDEHASE, Brockum (DE); Janina ALTMEPPEN, Georgsmarienhütte (DE)

(21) Appl. No.: 15/756,245

(22) PCT Filed: Aug. 9, 2016
(86) PCT No.: PCT/EP2016/068933

§ 371 Date: Feb. 28, 2018

(30) Foreign Application Priority Data
Sep. 9, 2015 (DE) 10 2015 217 219.8

(51) Int. Cl. F16C 11/06

(52) U.S. Cl. CPC F16C 11/0671; F16C 2326/24

(57) ABSTRACT

A protective cap for covering some areas of a fully assembled ball joint. The protective cap has an enclosing wall designed to enclose an area of the ball joint to be covered. The protective cap protects the ball joint, in some areas, against heat damage with at least one additional wall (3, 21) spaced a distance away from the enclosing wall (2, 22). In addition, a ball joint (30) has a sealing bellows (31) which is protected by the double-walled area (4, 27) of the protective cap (1, 20) against the damaging effects of heat. Also a two-point linkage (40), in particular for a utility vehicle, which includes a connecting tube (41) that is connected at least at one end section (42) to a ball joint (30).

This application is a National Stage completion of PCT/EP2016/068933 filed Aug. 9, 2016, which claims priority from German patent application serial no. 10 2015 217 219.8 filed Sep. 9, 2015.

### FIELD OF THE INVENTION

The invention concerns a protective cap, a ball joint comprising a protective cap of this type and two-point linkage comprising a ball joint of this.

### BACKGROUND OF THE INVENTION

Protective caps for covering some parts of a fully assembled ball joint are known from the prior art. DE 102 42 578 A1 discloses a protective cap having a wall designed to enclose an area of the ball joint that is to be covered. A sealing bellows of the ball joint is completely enclosed by the wall of the protective cap in such manner that the outer surface of the sealing bellows is in contact with the inside surface of the wall of the protective cap in some areas.

DE 102 23 306 A1 describes a ball joint with a housing, the housing being formed integrally with a shaft. The shaft has a serrated profile for connecting the shaft to a connecting tube. When the shaft has been pushed into an end section of the connecting tube, the end section of the connecting tube is compressed by a pressing device. Thereby, the inside contour of the end section of the connecting tube is fitted to the outer contour of the shaft. In practice, before it is compressed the end section of the connecting tube is often heated to temperatures above 800 degrees Celsius, whereas before the compression the shaft is not heated. The compression of the preheated end section of the connecting tube by hot forming is also known as hot swaging. Hot swaging has the advantage that a particularly tight fit between the end section of the connecting tube and the shaft of the ball joint is produced, because after the hot swaging the end section of the connecting tube enclosing the shaft shrinks during cooling and thereby grips the shaft tightly. A disadvantage of this method is that the sealing bellows can only be fitted after the hot swaging operation in order to avoid being damaged by the radiant heat given off by the preheated end section of the connecting tube after the hot swaging.

In the production of link rods, particularly link rode for trucks or buses, this means for example that the ball joint has to be preassembled first without a sealing bellows. Then, the shaft of the preassembled is joined to the end section of the connecting tube by hot swaging. Only after the end section of the connecting tube has cooled can the sealing bellows of the ball joint and a covering cap that protects the sealing bellows during later production processes be fitted in an additional working step. This entails relatively high complexity and cost, because the subassembly comprising the ball joint and the connecting tube is relatively bulky, depending on the dimensions of the link rod concerned. Tests have shown that a sealing bellows fitted before hot swaging is not protected sufficiently effectively by a fitted-on, single-walled protective cap according to DE 102 42 578 A1 from the radiant heat given off by the end section of the connecting tube after the hot swaging operation, particularly when the outer wall of the sealing bellows is partially in contact with the inside wall of the protective cap.

### SUMMARY OF THE INVENTION

The purpose of the present invention is to provide a protective cap which protects the sealing bellows from the damaging effects of heat during the hot swaging operation, so that the sealing bellows can be fitted on already before the hot swaging, during the process of assembling the ball joint.

According to the present invention, this objective is achieved by a protective cap of the type concerned which also embodies the characterizing features specified in the independent claims.

Preferred embodiments and further developments are the object of the subordinate claims.

Accordingly, the invention envisions a protective cap for covering some parts of a fully assembled ball joint, such that the protective cap comprises a wall designed to enclose an area of the ball joint that is to be covered. To protect the ball joint in parts against the damaging effects of heat, according to the invention the protective cap has at least one additional wall a distance away from its wall.

In the context of the present invention a fully assembled ball joint is understood to mean a ball joint which is functional and ready for fitting into a vehicle. In particular the ball joint comprises a ball stud which is fitted and able to rotate and pivot with a joint ball arranged at its end in a housing of the ball joint. A section of the ball stud extending away from the joint ball projects out of an opening in the housing and this housing opening is sealed against the penetration of dust, dirt and moisture by a sealing bellows. Whereas the housing and the ball stud are made of steel, the sealing bellows preferably consists of an elastomer material, which is more sensitive to temperature than the steel components of the ball joint. By virtue of the wall and the additional wall a distance away therefrom, a double-walled area of the protective cap with an air gap between the walls is formed. The heat-insulating effect of the air gap prevents heat coming from the outside onto the double-walled area from damaging the part of the fully assembled ball joint that can be covered by the double-walled area of the protective cap. In particular, at least part of the relatively temperature-sensitive sealing bellows is covered by the double-walled area in order to protect it against damaging radiated heat, especially heat from a hot joining process, particularly hot swaging.

Depending on the type and number of the heat sources, the protective cap can have an additional wall associated with one or more parts of the wall connected to or spaced apart from one another, these additional wall areas being a distance away from the wall. The at least one additional wall can for example be in the form of a type of shield in order to provide partial protection from the damaging effects of radiant heat. The protective cap with its wall and additional wall(s) is preferably made integrally and consists of plastic. The protective cap is advantageously produced by a plastic injection-molding process. The protective cap is preferably designed as a completely closed cup, wherein the wall in the upper area of the cup can be interrupted by one or more annular drainage openings. After its intended use the protective cap has the same geometrical and material properties as before it was used, so it can be used many times over.

Preferably, the additional wall is in the form of a closed ring. In this context a closed ring structure means that in the circumferential direction the additional wall extends uninterruptedly. In this way the above-described insulating effect against the effect of heat, in particular radiant heat, is produced at all points. In particular, the wall and the additional wall are of rotationally symmetrical shape.

According to a preferred design of the invention, the additional wall is arranged outside the wall. Preferably, the wall is enclosed by the additional wall in a ring-like manner in some areas. An additional wall arranged radially outside the wall is advantageous, because during assembly of the protective cap it is visible at all times, so that so-termed concealed joining of an additional wall not visible from the outside is avoided.

In an alternative embodiment of the invention the additional wall is arranged radially inside the wall. In this design the outer circumferential surface of the wall at the same time forms the outer circumferential surface of the protective cap. Thus, in the axial direction the outer surface of the protective cap has a continuous shape not structurally interrupted by an additional wall. Furthermore, due to its position radially inside the wall the additional wall is well protected against mechanical damage. To ensure that the protective cap can be produced by, and in particular de-molded after, an injection-molding work step, when the additional wall is on the inside the protective cap, it can be made in more than one part, for example with an additional wall that can be clipped or pressed into position in the protective cap.

Preferably, the distance between the wall and the additional wall is constant all round the additional wall. This ensures that the double-walled area can perform its insulating function in the same way all round its circumference. This has the advantage that when the protective cap, which is in particular substantially rotationally symmetrical, is fitted on or screwed in place, no additional orientation of the double-walled area relative to the heat source present is necessary. If due to an assembly error the central axis of the protective cap does not coincide with the central axis of the ball joint, despite this the insulating action of the protective cap is still obtained. The heat-insulating effect given by the constant distance between the wall and the additional wall is also effective when the outer surface of the sealing bellows is in contact with the inside surface of the wall or the additional wall.

In an advantageous further development of the invention, an intermediate space between the wall and the additional wall is left open in the axial direction at least at one end. This has the advantage that when the double-walled area is exposed to radiant heat the air in the air gap, which expands because of the heat, can escape from the intermediate space. Moreover, thanks to the open structure of the intermediate space at least at one end it can be well ventilated during the action of the heat, and this effectively prevents heat accumulation. In particular the intermediate space has two openings at opposite ends in the axial direction of the protective cap, so that during the action of radiant heat the heated air can escape from the intermediate space and cooler air can flow in to replace it. When the additional wall is arranged radially inside the wall, then if the intermediate space is made open at both ends it can be ventilated from one axial end by way of the drainage opening(s) that extend through an upper section of the wall of the protective cap.

Advantageously, the wall and the additional wall are essentially cylindrical in a double-walled area. If the protective cap is made as an injection-molded plastic component the shape can deviate slightly from a perfectly cylindrical shape due to production-related, necessary mold-release chamfers. Preferably, in the double-walled area already described earlier the wall and the additional wall are arranged concentrically with one another. In this design the intermediate space, particularly when it is open at both ends in the axial direction of the protective cap, is also at least essentially cylindrical. This ensures that at every point all the way round the circumference of the protective cap the heat-insulating effect will be the same, regardless of which part of the circumference in the fitted position of the protective cap happens by chance to be facing toward the heat source.

Preferably, the distance between the wall and the additional wall is bridged in some sections by a fin structure. The fin structure serves to connect the additional wall to the wall and is arranged in the intermediate space. In particular the fin structure is formed integrally with the wall and the additional wall. Alternatively, the fin structure can also be integral only with the wall or with the additional wall, for example if the additional wall is made as a separate component which is connected to the wall of the protective cap by clipping it or pressing it into position.

According to a further development of the invention the fins of the fin structure extend in the axial direction of the protective cap. With this design, when the protective cap is exposed to heat, effective air exchange into and out of the intermediate space can take place in the axial direction of the protective cap. By virtue of this air exchange, cool ambient air can continually be passed into the intermediate space and thereby excessive heating of the wall areas of the wall and additional wall facing the intermediate space can be avoided.

The invention also concerns a ball joint with a sealing bellows, wherein the sealing bellows is protected at least in some areas by the double-walled part of a protective cap as described earlier, against the damaging effects of heat, in particular radiant heat. In particular, the part of the sealing bellows facing toward the radiation source is covered by the double-walled area of the protective cap. Thanks to the heat-insulating effect of the air gap between the wall and the additional wall a distance away from it, the protection of the sealing bellows against damage due to temperature effects is ensured, even if the outer wall of the sealing bellows is in contact with the inside wall of the double-walled part in some areas.

Preferably, the ball joint has a shaft with a serrated profile in part or completely around it. In particular, the shaft is of essentially cylindrical shape and is formed integrally with the housing of the ball joint. The serrations of the serrated profile do not form spirals in the manner of a thread, but are individual serrations arranged parallel to one another along the longitudinal extension of the shaft, which can be formed all round or not all round. When the serrations are not formed all round, then according to DE 102 23 306 A1 they are arranged, as viewed in a cross-section, in two circumferential sections of equal size separate from and opposite one another. The serrated profile on the shaft can be produced by machining or not by machining, in particular by primary shaping or by deformation.

Furthermore, the invention proposes a two-point linkage, particularly for a utility vehicle, such that the two-point linkage comprises a connecting tube which is connected at least at one end section to a ball joint as described above. In particular, the end section of the connecting tube is connected both with interlock and by friction to the shaft of the ball joint. For that purpose the inside diameter of the end section of the connecting tube is advantageously made slightly larger than the maximum outer diameter of the shaft. To produce a serrated contour of the end section of the connecting tube that corresponds in shape to the serrated profile of the shaft, the shaft is advantageously pushed into the preheated end section of the connecting tube. Then the two joint partners are connected to one another by hot swaging. By virtue of the shrinkage that takes place during the subsequent cooling of the end section of the connecting tube, in addition to the interlocked connection formed by the shape-matching serrated profiles a frictional connection is also ensured.

Due to the heat-insulating effect of the protective cap, the ball joint can be connected in its fully assembled condition to the end section of the connecting tube by hot swaging. It is no longer necessary to fit the sealing bellows at a later stage. The protective cap preferably stays in place on the ball stud even during a post-assembly surface treatment of the two-point linkage and during the subsequent making ready for dispatch and transport to the customer. Preferably, the protective cap is only removed just before the fitting of the two-point linkage into the vehicle, for example into a truck or a bus.

In particular, the two-point linkage is in the form of a steering rod, a track rod, a stabilizer tie-rod, an operating linkage or a Panhard rod.

### BRIEF DESCRIPTION OF THE DRAWINGS

Below, the invention is explained in more detail with reference to drawings that illustrate embodiments intended only as examples, in which the same indexes refer to the same components or elements, and which show:

FIG. 1: A perspective view of a protective cap according to a first embodiment of the invention;

FIG. 2: A sectioned view of the protective cap shown in FIG. 1;

FIG. 3: A sectioned view of a protective cap according to a second embodiment of the invention;

FIG. 4: A sectioned view of a ball joint with a protective cap according to the first embodiment; and

FIG. 5: A partially sectioned representation of a two-point linkage with ball joints arranged at its ends, wherein one of the ball joints is covered by a protective cap according to the first embodiment.

### DETAILED DESCRIPTION OF THE PREFERRED EMBODIMENTS

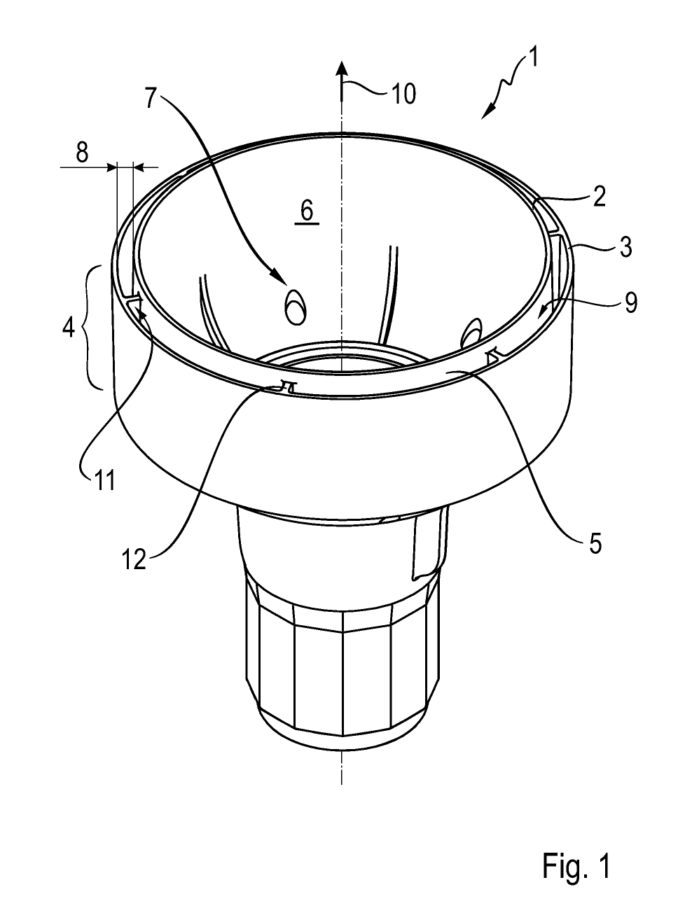

FIG. 1 shows a protective cap 1 for the partial covering of a fully assembled ball joint 30, wherein the protective cap 1 comprises a wall 2 designed to enclose an area of the ball joint 30 that is to be covered. To protect some parts of the ball joint 30 against damaging effects of heat, the protective cap 1 has an additional wall 3 a distance away from the wall 2. By virtue of the wall 2 and the additional wall 3 a distance away from it, a double-walled area 4 of the protective cap 1 with an air layer 5 between the walls is provided. A heat-insulating effect of the air layer 5 prevents heat, acting from the outside on the double-walled area 4, from damaging the part of the fully assembled ball joint 30 that can be covered by the double-walled area 4 of the protective cap 1. The protective cap 1 with its wall 2 and its additional wall 3 is made integrally as one piece, and consists of plastic. The additional wall 3 is in the form of a closed ring and is arranged radially outside the wall 2. The wall 2 and the additional wall 3 are of rotationally symmetrical shape and are arranged concentrically with one another.

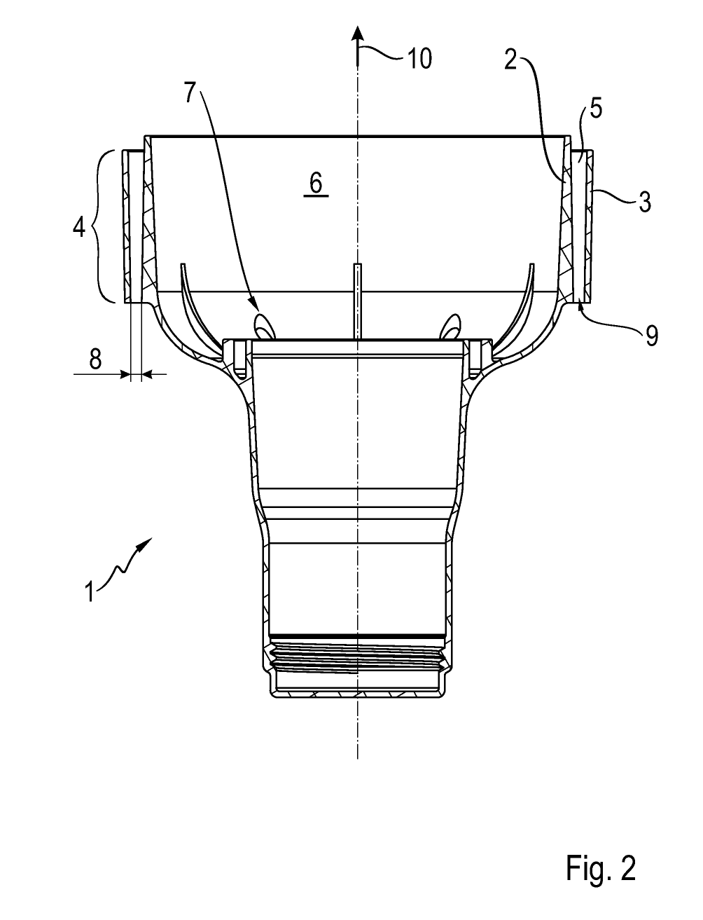

As can be seen in FIG. 2, the protective cap 1 is in the form of a completely closed cup, wherein, in an upper part 6 which is arranged in the upper area of the cup, a number of drainage openings 7 are arranged in a ring and pass through the wall 2. The distance 8 between the wall 2 and the additional wall 3 is constant all round the additional wall 3. An intermediate space 9 between the wall 2 and the additional wall 3 is left open at both ends in the axial direction 10 of the protective cap 1. The wall 2 and the additional wall 3 are of essentially cylindrical shape in the double-walled area 4. Due to production-related, necessary mold-release chamfers, the cylindrical design deviates slightly from an exactly cylindrical shape because the protective cap 1 is produced as an injection-molded plastic component. The wall 2 and the additional wall 3 are arranged concentrically with one another. Consequently, the intermediate space 9 open at both ends in the axial direction 10 of the protective cap 1 is also essentially cylindrical. The distance 8 between the wall 2 and the additional wall 3 is bridged in some places by a fin structure 11. The fin structure 11 that can be seen in FIG. 1 serves to connect the additional wall 3 to the wall 2 and is arranged in the intermediate space 9. At the same time, the fin structure 11 is also made integrally with the wall 2 and the additional wall 3. The fins 12 of the fin structure 11 extend in the axial direction 10 of the protective cap 1.

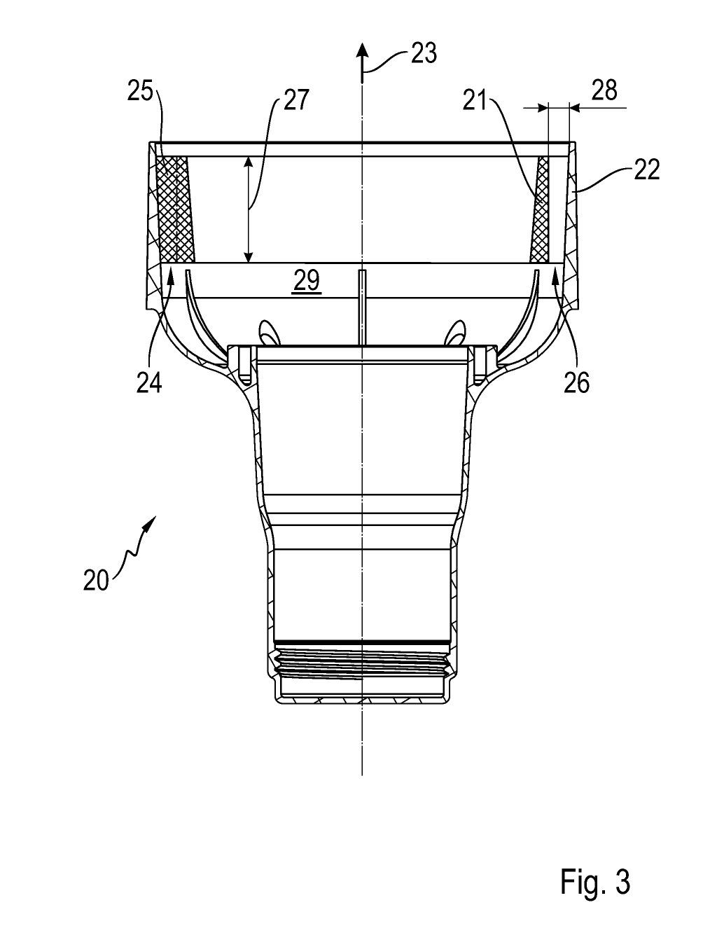

FIG. 3 shows a protective cap 20 with an additional wall 21 which is arranged radially inside the wall 22 of the protective cap 20 to form a double-walled area 27. In this embodiment the outer circumferential surface of the wall 22 at the same time forms the outer circumferential surface of the protective cap 20. In the axial direction 23 of the protective cap 20, the outer circumferential surface of the protective cap 20 extends continuously. The distance 28 between the wall 22 and the additional wall 21 is bridged in some areas by a fin structure 24 having five fins 25 distributed uniformly around the circumference. The additional wall 21 and the fins 25 are made as a separate component and press-fitted onto an upper part 29 of the protective cap 20. The fin 25, which can be seen in the left half of the figure, is in the plane of the section and is therefore shown in section. In the right half of the figure there is no fin in the plane of the section. The intermediate space 26 between the wall 22 and the additional wall 21 is open at each end in the axial direction 23 of the protective cap 20.

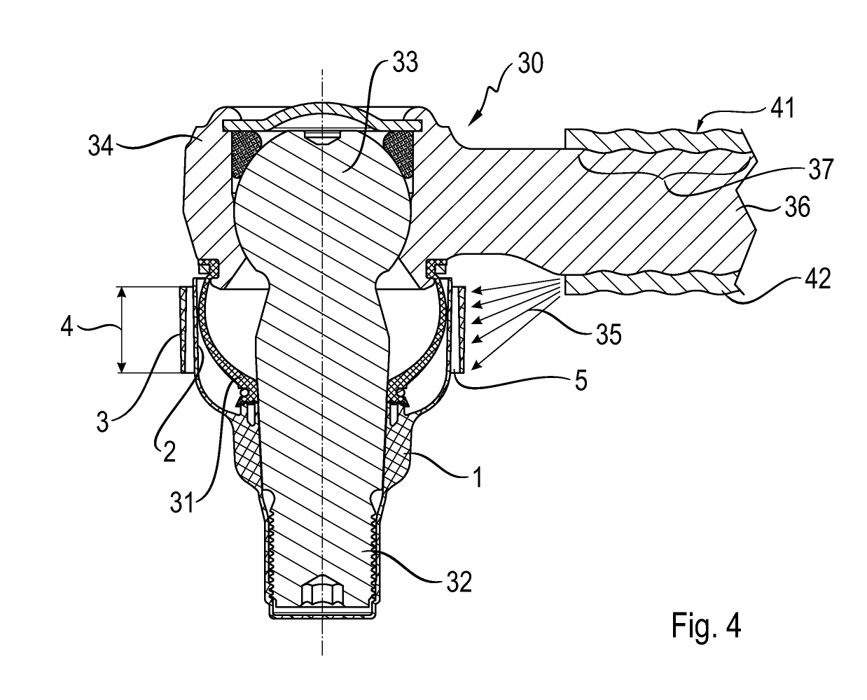

FIG. 4 shows a ball joint 30 with a sealing bellows 31, wherein the sealing bellows 31 is protected in some areas against damaging radiant heat 35 by the double-walled area 4 of the protective cap 1 according to the first example embodiment. The ball joint 30 has a ball stud 32 which, with a joint ball 33 at its end, is fitted and able to rotate and pivot in a housing 34 of the ball joint 30. A section of the ball joint extending away from the joint ball 33 projects out of an opening of the housing 34, this housing opening being sealed by the sealing bellows 31. Whereas the housing 34 and the ball stud 32 are made from different ferrous materials, the sealing bellows 31 consists of an elastomer material which is more temperature-sensitive than the components of the ball joint 30 made of ferrous materials. The area of the outer surface of the sealing bellows 31 facing toward the radiation source is covered by the double-walled area 4 of the protective cap 1. By virtue of the heat-insulating effect of the air layer 5 between the wall 2 and the additional wall 3 a distance away from it, the protection of the sealing bellows 31 against damage by radiant heat 35 is ensured.

The ball joint 30 has a shaft 36 with an all-round serrated profile 37, the shaft being essentially cylindrical and made integrally with the housing 34 of the ball joint 30. The serrations of the serrated profile 37 are in the form of several individual serrations running parallel with one another in the direction of the longitudinal extension of the shaft 36. The serrations are produced by machining.

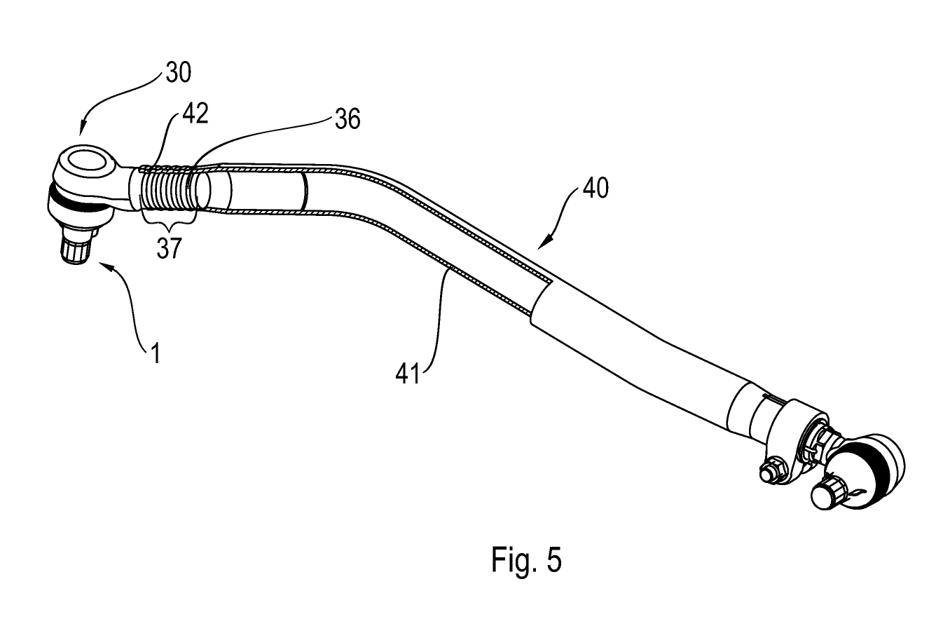

FIG. 5 shows a two-point linkage in the form of a steering rod 40, which is particularly suitable for a utility vehicle. The steering rod 40 comprises a connecting tube 41 connected at an end section 42 to the above-described ball joint 30. The end section 42 of the connecting tube 41 is connected by both interlock and friction to the shaft 36 of the ball joint 30. The inside diameter of the end section 42 of the connecting tube 41 is made slightly larger than the maximum outer diameter of the shaft 36. To produce a serrated contour of the end section 42 of the connecting tube 41 that corresponds in shape with the serrated profile 37 of the shaft 36, the shaft 36 is pushed into the previously heated end section 42 of the connecting tube 41. Then, the two joint partners are connected to one another by hot swaging. Due to the shrinkage during the subsequent cooling of the end section 42 of the connecting tube 41, besides the interlocked connection due to the shape-matched serrated profiles a frictional connection is also produced. To protect the relatively temperature-sensitive sealing bellows 31 against damage due to radiant heat during the cooling of the end section 42, the bellows is covered by the double-walled area 4 of the protective cap.

### INDEXES

1 Protective cap
2 Wall
3 Additional wall
4 Double-walled area
5 Air layer
6 Upper section
7 Drainage opening
8 Distance
9 Intermediate space
10 Axial direction
11 Fin structure
12 Fin
20 Protective cap
21 Additional wall
22 Wall
23 Axial direction
24 Fin structure
25 Fin
26 Intermediate space
27 Double-walled area
28 Distance
29 Upper section
30 Ball joint
31 Sealing bellows
32 Ball stud
33 Joint ball
34 Housing
35 Radiant heat
36 Shaft
37 Serrated profile
40 Two-point linkage
41 Connecting tube
42 End section

1-13. (canceled)

14. A protective cap (1, 20) for covering some areas of a fully assembled ball joint (30),
the protective cap (1, 20) having an enclosing wall (2, 22) designed to enclose an area of the ball joint (30) that is to be covered, and
the protective cap (2, 22) having at least one additional wall (3, 21), spaced a distance away from the enclosing wall (2, 22), for the protection of some areas of the ball joint (30) against damaging effects of heat.

15. The protective cap (1, 20) according to claim 14, wherein the additional wall (3, 21) is in a form of a closed ring.

16. The protective cap (1) according to claim 14, wherein the additional wall (3) is arranged radially outside the enclosing wall (2).

17. The protective cap (20) according to claim 14, wherein the additional wall (21) is arranged radially inside the enclosing wall (22).

18. The protective cap (1, 20) according to claim 14, wherein the distance (8) between the enclosing wall (2, 22) and the additional wall (3, 21) is constant all the way round the additional wall (3, 21).

19. The protective cap (1, 20) according to claim 14, wherein at least at one end os an intermediate space (9, 26), between the enclosing wall (2, 22) and the additional wall (3, 21), is open in an axial direction (10, 23) of the protective cap (1, 20).

20. The protective cap (1, 20) according to claim 14, wherein the enclosing wall (2, 22) and the additional wall (3, 21) are shaped at least substantially cylindrically in a double-walled area (4, 27).

21. The protective cap (1, 20) according to claim 14, wherein the distance (8, 28) between the enclosing wall (2, 22) and the additional wall (3, 21) is bridged, in some areas, by a fin structure (11, 24).

22. The protective cap (1, 20) according to claim 21, wherein fins (12, 25) of the fin structure extend in an axial direction (10, 23) of the protective cap (1, 20).

23. A ball joint (30) with a sealing bellows (31), the sealing bellows (31) is protected at least in some areas by a double-walled area (4, 27) of a protective cap (1, 20) against damaging effects of heat, the protective cap covering some areas of a fully assembled ball joint (30), the protective cap (1, 20) having an enclosing wall (2, 22) designed to enclose an area of the ball joint (30) that is to be covered, for the protection of the areas of the sealing bellows against the damaging effects of heat, and the protective cap (2, 22) having at least one additional wall (3, 21) spaced a distance away from the enclosing wall (2, 22).

24. The ball joint (30) according to claim 23, wherein the ball joint (30) has a shaft (36) with a serrated profile (37) either partially or completely all-round the shaft.

25. A two-point linkage (40) for a utility vehicle, the two-point linkage (40) comprising:
a connecting tube (41) which, at least at one end section (42), is connected to a ball joint (30) having a sealing bellows (31),
the sealing bellows (31), at least in some areas, being protected by a double-walled area (4, 27) of a protective cap (1, 20) against damaging effects of heat,
the protective cap covering some areas of a fully assembled ball joint (30),
the protective cap (1, 20) having an enclosing wall (2, 22) designed to enclose the areas of the sealing bellows against the damaging effects of heat, and
the protective cap (2, 22) having at least one additional wall (3, 21) spaced a distance away from the enclosing wall (2, 22).

26. The two-point linkage (40) according to claim 25, wherein the two-point linkage is in a form of one of a steering rod (40), a track rod, a stabilizer tie-rod, an operating linkage and a Panhard rod.
